(19) United States
(12) Patent Application Publication
(10) Pub. No.: US 2018/0030700 A1
(43) Pub. Date: Feb. 1, 2018

(54) FAUCET

(71) Applicant: BLANCO GmbH + Co KG, Oberderdingen (DE)

(72) Inventors: Johann Zindler, Bretten (DE); Bernd Becker, Kürnbach (DE); Eric Gundersen, Medford, NJ (US)

(21) Appl. No.: 15/655,719

(22) Filed: Jul. 20, 2017

(30) Foreign Application Priority Data
Jul. 27, 2016 (DE) 10 2016 113 832.0

(51) Int. Cl. E03C 1/05; F16K 11/00; E03C 1/04

(52) U.S. Cl. CPC E03C 1/057; E03C 1/0405; F16K 19/006; E03C 2001/0415

(57) ABSTRACT

In order to provide a faucet comprising a base, a hose spray unit and an arm held on the base, wherein the arm comprises a hose spray unit receptacle on which the hose spray unit is releasably held in a rest position, wherein the passage of water through the hose spray unit is controllable particularly easily and rapidly by an operating person, it is proposed that the faucet comprises a sensor for detecting the presence and/or the movement of a hand of an operating person in a detection region of the sensor, wherein the sensor is arranged on the arm.

### RELATED APPLICATION

The present disclosure relates to the subject matter disclosed in German Patent Application No. 10 2016 113 832.0 of Jul. 27, 2016, the entire specification of which is incorporated herein by reference.

### FIELD OF DISCLOSURE

The present invention relates to a faucet which comprises a base, a hose spray unit and an arm held on the base, wherein the arm comprises a hose spray unit receptacle on which the hose spray unit is releasably held in a rest position.

### BACKGROUND

Fittings of this type are known, for example under the designation “semi-professional faucet”.

With such fittings, the passage of water through the hose spray unit is controlled by an operating person by actuation of a selection lever on a mixing valve of the faucet or by actuation of a switch on a spray nozzle of the hose spray unit.

### SUMMARY OF THE INVENTION

It is an object of the present invention to provide a faucet of the aforementioned type in which the passage of water through the hose spray unit is controllable particularly easily and rapidly by an operating person.

This object is achieved according to the invention with a faucet having the features of the preamble of claim 1 in that the faucet comprises a sensor for the detection of the presence and/or the movement of a hand of an operating person in a detection region of the sensor, wherein the sensor is arranged on the arm of the faucet.

In that, with the faucet according to the invention, the sensor is arranged on the arm which is preferably directed from the base of the faucet forwardly toward the operating person, an operating person can effect an activation of the passage of water through the hose spray unit and/or a stopping of the passage of water through the hose spray unit by means of a very short hand movement from the region of the hose spray unit receptacle into the detection region of the sensor.

Herein, the hand of the operating person alone or together with a handle portion of the hose spray unit with which the hand of the operating person engages, can be moved into the detection region of the sensor.

If a sensor is arranged at the outlet of a faucet or on the base of a faucet, then the actuating route for the hand of an operating person to the relevant sensor is long, which causes the actuation of the faucet by the operating person to be slowed and awkward. Furthermore, a sensor positioned at the outlet or on the base of the faucet can result in increased false actuations.

A positioning of a sensor at the outlet or on the base of a faucet disrupts the design of the faucet.

The positioning of the sensor close to the hose spray unit receptacle permits activation of a signal generation of the sensor by a very short movement of the hand of the operating person without frequent false actuations occurring thereby.

A false actuation by the operating person during handling of objects in a basin, in particular in a wash basin, is largely precluded.

In a preferred embodiment of the invention, it is provided that the arm of the faucet has a sensor receptacle in which the sensor is at least partially accommodated.

It is particularly favourable if the sensor is substantially completely accommodated in the sensor receptacle. By this means, the sensor is protected, in particular, against splashed water.

The sensor receptacle preferably has a sensor aperture through which the sensor is accessible from an external space of the faucet.

Such a sensor aperture can be closed by a, preferably transparent, cover.

In principle, depending on the functionality, the detection region of the sensor can be arranged above the arm, laterally beside the arm or beneath the arm.

In a preferred embodiment of the invention, it is provided that the detection region of the sensor is arranged beneath the arm, in particular, vertically under the arm.

For this purpose, it is advantageous if the sensor aperture is arranged on an underside of the arm, preferably facing toward the base of the faucet.

In the region in which the sensor is arranged, the arm preferably has a substantially rectangular or oval cross-section.

In order to offer sufficient space for the accommodation of the sensor in the arm, it is preferably provided that, in the region in which the sensor is arranged, the arm has a thickness, that is, a horizontal extent in the assembled state of the faucet perpendicular to a longitudinal axis of the arm, of at least approximately 10 mm, in particular of at least approximately 15 mm.

In principle, the sensor can be configured as any desired proximity and/or movement sensor.

For example, the sensor can be configured as an infrared sensor, an ultrasonic sensor, an inductive sensor or a capacitive sensor.

In a preferred embodiment of the invention, it is provided that the sensor comprises an infrared sensor and is preferably configured as an infrared sensor.

Further, the faucet preferably comprises a control device which controls a stop valve which permits or blocks the passage of water through the hose spray unit when the sensor detects the presence and/or the movement of a hand of an operating person in the detection region of the sensor.

The stop valve can be configured, in particular, as an electromagnetic valve.

In order, in addition to the control of the passage of water through the hose spray unit, to provide by means of the sensor a further control possibility for the operating person, it can be provided that the hose spray unit comprises a switch for permitting and/or blocking the passage of water through the hose spray unit and/or for switching over between different jet forms of the water jet emerging from the hose spray unit.

Such a switch can be arranged, in particular, on a handle portion of the hose spray unit.

Preferably provided between the handle portion of the hose spray unit and the coupling of the hose spray unit to the base of the faucet, is a bendingly flexible hose portion of the hose spray unit.

The switch is preferably arranged lower than the sensor when the hose spray unit is held in the rest position on the arm, in particular, on the hose spray unit receptacle of the arm.

The hose spray unit can comprise a bendingly flexible hose portion.

The bendingly flexible hose portion is preferably arranged, at least partially and/or, in particular, substantially completely, outside the arm of the faucet, when the hose spray unit is held on the hose spray unit receptacle in the rest position.

Furthermore, the hose spray unit can be provided with a covering made of a metallic material, in particular, a stainless steel material.

This covering can be configured, in particular, as a corrugated hose.

In principle, the arm of the faucet can be arranged non-rotatably on the base of the faucet and protrude from the base, in particular in the assembled state of the faucet, forwardly toward an operating person, so that in particular an outlet opening of the hose spray unit is arranged, in the rest position of the hose spray unit, over a basin, in particular, a wash basin with which the faucet is associated.

In a preferred embodiment of the invention, however, it is provided that the arm is pivotably held on the base.

Particularly preferably, the arm is held pivotable about a vertical pivot axis on the base.

In order to keep the actuating movement for the activation of the sensor by the operating person as small as possible, it is favourable if in the assembled state of the faucet, the horizontal spacing d_{B} of the sensor from the hose spray unit in its rest position is smaller than the horizontal spacing d_{S} of the sensor from the pivot axis about which the arm is pivotably held on the base.

In the case of an arm arranged stationary on the base, it is favourable if, in the assembled state of the faucet, the horizontal spacing d_{B} of the sensor from the hose spray unit, when the hose spray unit is held in the rest position on the hose spray unit receptacle, is smaller than the horizontal spacing d_{S} of the sensor from a vertical longitudinal central axis of the base.

For the design impression of the faucet it is particularly favourable if the sensor is not visible to an operating person when observing the faucet from a position above the arm.

This can be achieved, in particular, in that the sensor is arranged completely in a sensor receptacle of the arm which has a sensor aperture arranged on an underside of the arm.

The sensor can be arranged, in particular, on a cantilevered portion of the arm which connects the hose spray unit receptacle of the arm to a base portion on which the arm is held, preferably pivotably, on the base of the faucet.

Such a cantilevered portion preferably extends substantially along a radial direction of the pivot axis about which the arm is pivotably held on the base and/or in a radial direction of a vertical longitudinal central axis of the base.

Herein, a longitudinal axis of the cantilevered portion can be tilted relative to the radial direction by an acute angle of preferably not more than 10°.

Preferably this tilting is such that the cantilevered portion rises with increasing spacing from the pivot axis or from the vertical longitudinal central axis of the base.

Further features and advantages of the invention are the subject matter of the following description and of the illustration in the drawings of an exemplary embodiment.

### BRIEF DESCRIPTION OF THE DRAWINGS

FIG. 1 shows a side view of a faucet which comprises a base, a hose spray unit and an arm held pivotably on the base with a hose spray unit receptacle, on which the hose spray unit is releasably held in a rest position;

FIG. 2 shows a front view of the faucet of FIG. 1 seen in the direction of the arrow 2 in FIG. 1; and

FIG. 3 shows a view of the faucet of FIGS. 1 and 2 from underneath with the view in the direction of the arrow 3 in FIG. 1.

The same or functionally equivalent elements are identified in all the drawings with the same reference signs.

### DETAILED DESCRIPTION OF THE INVENTION

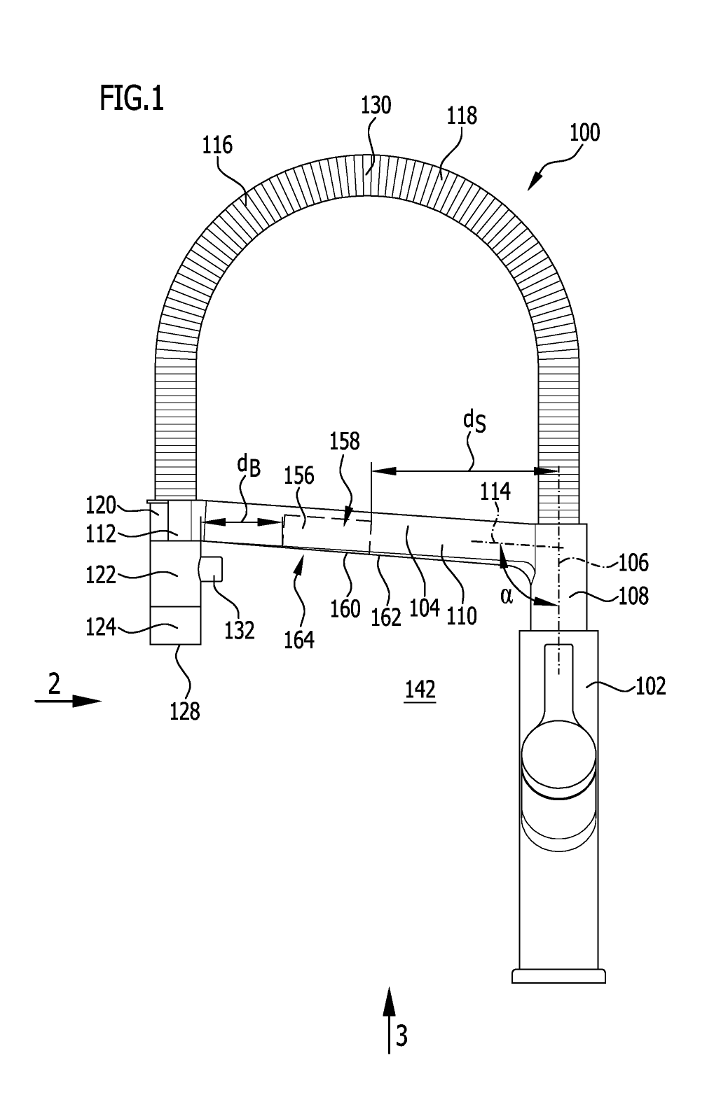

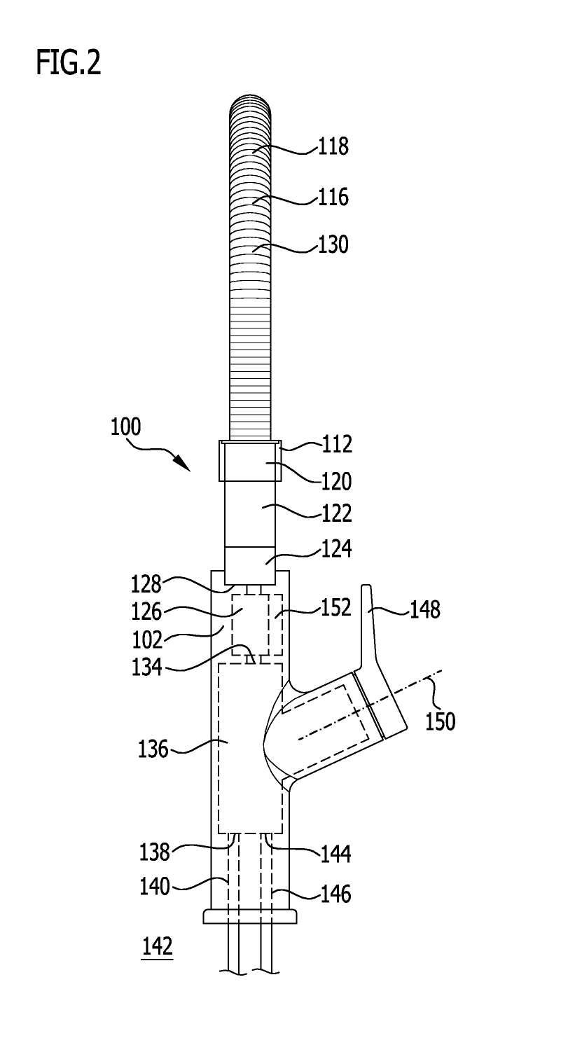

A faucet shown in FIGS. 1 to 3, identified overall as 100, which is provided for use on a basin, in particular on a kitchen sink, comprises a base 102 which is fixable to a suitable support, for example, on a sink or a worktop, and an arm 104 carried by the base 102.

The arm 104 is preferably held pivotable about a pivot axis 106 on the base 102.

In the assembled state of the faucet 100, the pivot axis 106 is substantially vertically oriented.

The arm 104 comprises a base portion 108 which is preferably substantially configured as a hollow cylinder and its longitudinal central axis preferably substantially coincides with the pivot axis 106, a cantilevered portion 110 extending substantially in the radial direction of the pivot axis 106 away from the base portion 108 and a hose spray unit receptacle 112 arranged at the end of the cantilevered portion 110 facing away from the base portion 108.

In the assembled state of the faucet 100, the cantilevered portion 110 preferably extends starting from the base portion 108 as far as the hose spray unit receptacle 112 somewhat upwardly, so that a longitudinal axis 114 of the cantilevered portion 110 includes an oblique angle a with the pivot axis 106, preferably an angle between approximately 90° and approximately 100°, for example, approximately 94°.

The base 102 and/or the arm 104 of the faucet 100 is preferably made of a metallic material, in particular, a stainless steel material.

The faucet 100 further comprises a hose spray unit 116 which in turn comprises a hose portion 118 which is pivotably connected to the base 102, a holder portion 120 arranged on the end of the hose portion 118 facing away from the base 102, a handle portion 122 arranged on the side of the holder portion 120 facing away from the hose portion 118 and an outlet portion 124 arranged on the side of the handle portion 122 facing away from the holder portion 120.

The hose spray unit 116 contains a mixed water conduit 116 (not shown) which is connected on one side to an outlet of a stop valve 126 arranged in the base 102 and on the other side at an end face 128 of the outlet portion 124 of the hose spray unit 116 opens into the exterior of the hose spray unit 116.

The hose portion 118 of the hose spray unit 116 is configured bendingly flexible and can comprise, in particular, a covering 130 which is preferably made from a corrugated hose.

The covering 130 can be formed, in particular, from a metallic material, for example, a stainless steel material.

The holder portion 120 of the hose spray unit 116 is preferably configured at least partially complementary to the hose spray unit receptacle 112 of the arm 104 and is preferably so configured that it is releasably fixable on the hose spray unit receptacle 112 in a rest position of the hose spray unit 116 illustrated in FIGS. 1 to 3.

The releasable fixing of the holder portion 120 of the hose spray unit 116 on the hose spray unit receptacle 112 of the arm 104 can take place, for example, by means of positive engagement and/or force-locking.

In particular, it can be provided that the holder portion 120 is fixable on the hose spray unit receptacle 112 by means of magnetic force.

For this purpose, it can be provided, in particular, that the holder portion 120 comprises a permanent magnet element and the hose spray unit receptacle 112 contains a magnetisable, in particular, ferromagnetic material.

Conversely, it can also be provided that the holder portion 120 comprises a magnetisable, in particular ferromagnetic material and the hose spray unit receptacle 112 comprises a permanent magnet element.

The handle portion 122 of the hose spray unit 116 is provided so that an operating person grasps the handle portion 122 in order to release the hose spray unit 116 from its rest position in which the holder portion 120 is releasably fixed to the hose spray unit receptacle 112 and to move it into an operating position in which water is to flow out of the outlet portion 124 of the hose spray unit 116.

The handle portion 122 can be provided with a switch 132 that is actuatable by the operating person, by means of which the passage of water through the handle portion 122 of the hose spray unit 116 can be released or blocked and/or by means of which it is possible to switch between different jet forms of the water jet emerging from the hose spray unit 116.

For example, it can be provided that the outlet cross-section and/or the outlet angle of the water jet at the outlet opening of the outlet portion 124 are changeable by means of the switch 132.

The stop valve 126 is arranged upstream of a mixed water outlet 134 of a mixing valve 136 which is preferably arranged in the base 102 of the faucet 100.

Connected to a hot water inlet 138 of the mixing valve 136 is a hot water feed conduit 140 which extends out of the base 102 into the exterior 142 of the faucet 100 and there to a hot water source (not shown).

Connected to a cold water inlet 144 of the mixing valve 136 is a cold water feed conduit 146 which extends out of the base 102 into the external space 142 of the faucet 100 and there to a cold water source (not shown).

The volume flow and the temperature of the mixed water flowing through the mixed water outlet 134 of the mixing valve 136 are settable by means of the mixing valve 136.

For example, the mixing valve 136 can comprise an actuating lever 148 which is movable in two degrees of freedom, for example, by rotation about a pivot axis 150 (in the assembled state of the faucet 100, oriented inclined to the horizontal or substantially horizontally) and by tilting relative to the pivot axis 150.

Herein, one of the degrees of freedom of the actuating lever 148, for example the rotation, determines the ratio in which the hot water from the hot water inlet 138 of the mixing valve 136 and the cold water from the cold water inlet 144 of the mixing valve 136 are mixed with one another, and thus the temperature of the mixed water leaving the mixed water outlet 134 of the mixing valve 136, whilst the respective other degree of freedom of the actuating lever 148, for example the tilting, determines the volume flow through the mixed water outlet 134 of the mixing valve 136.

The stop valve 126 which is preferably arranged upstream from the mixing valve 136 serves to block or permit the passage of water through the hose spray unit 116.

The stop valve 126 can be formed, in particular, as an electromagnetic valve.

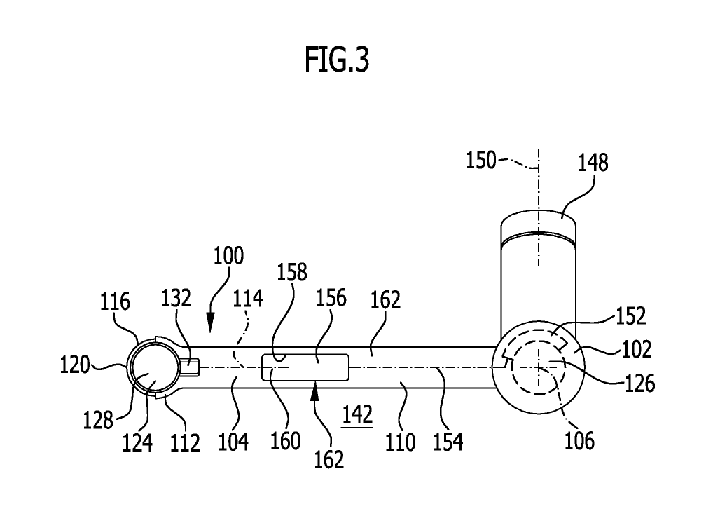

The stop valve 126 is controlled by a control device 152 which is preferably connected by means of a signal line 154 to a sensor 156 (see FIG. 3).

The control device 152 and the sensor 156 are connected via electrical supply lines (not shown) to a voltage source (not shown), for example the domestic power network or to a battery or an accumulator.

The sensor 156 is arranged on the arm 104 of the faucet 100, specifically preferably on the cantilevered portion 110 of the arm 104.

In particular, it can be provided that the arm 104 has a sensor receptacle 158 in which the sensor 156 is at least partially received, preferably substantially completely.

The sensor receptacle 158 has a sensor aperture 160 through which the sensor 156 is accessible from the external space 142 of the faucet 100 and through which the external space 142 of the faucet 100 is accessible from the sensor 156.

The sensor aperture 160 can be closed by a, preferably transparent, covering.

The sensor aperture 160 is preferably arranged on an underside 162 (in particular, facing toward the base 102) of the arm 104, in particular, the cantilevered portion 110 of the arm 104.

The arm 104, in particular the cantilevered portion 110 of the arm 104 preferably has in the region thereof in which the sensor 156 is arranged, a substantially rectangular or oval cross-section, considered perpendicularly to the longitudinal axis 114 of the cantilevered portion 110.

The sensor 156 is configured so that it detects a presence and/or a movement of a hand of an operating person in a detection region 164 of the sensor 156 and in the event of the detection, generates a signal which the sensor 156 transmits to the control device 152 of the stop valve 126.

The signal can be transmitted by means of the signal line 154. Alternatively thereto, a device for the wireless transmission of the signal from the sensor 156 to the control device 152 can be provided.

In reaction to the transmitted signal, the control device 152 switches the stop valve 126 over, that is, from the blocking position in which the passage of water through the hose spray unit 116 is blocked by the stop valve 126, into the release position in which the stop valve 126 permits the passage of water through the hose spray unit 116, or from the release position back into the blocking position.

The detection region 164 is preferably arranged beneath the arm 104 in front of the sensor aperture 160.

The operating person operating the faucet 100 can thus start the passage of water through the hose spray unit 116 in that he moves a hand in the detection region 164 of the sensor 156 and can stop the passage of water through the hose spray unit 116 at a later time in that he again moves a hand in the detection region 164 of the sensor 156.

The detection of the presence and/or the movement of the hand of the operating person in the detection region 164 herein preferably takes place contactlessly, that is, without the hand of the operating person coming into contact with the sensor 156.

In the assembled state of the faucet 100, the horizontal spacing d_{B} of the sensor 156 from the hose spray unit 116, in particular, from the handle portion 122 and/or from the holder portion 120 of the hose spray unit 116 held on the hose spray unit receptacle 112 is preferably smaller than the horizontal spacing dₛ of the sensor 156 from the pivot axis 106 about which the arm 104 is pivotable relative to the base 102.

Thus the sensor 156 is arranged closer to the hose spray unit 116 (in the rest position of the hose spray unit 116) than to the pivot axis 106.

The hand of an operating person therefore only has to cover a small path from the hose spray unit receptacle 112 to the detection region 164 of the sensor 156 or from the detection region 164 of the sensor 156 to the hose spray unit receptacle 112, which simplifies and accelerates the actuation of the stop valve 126 by means of the sensor 156 by the operating person.

Herein, the sensor 156 and the sensor aperture 160 are not visible to an operating person observing the faucet 100 from a position above the arm 104.

In principle, the sensor 156 can be configured as any desired proximity and/or movement sensor.

For example, the sensor 156 can be configured as an infrared sensor, an ultrasonic sensor, an inductive sensor or a capacitive sensor.

It is preferably provided that the sensor 156 is configured as an infrared sensor.

In particular, it can be provided that the sensor 156 emits a beam, for example, an infrared beam or an ultrasonic beam which is reflected by the hand of an operating person and is then detected by the sensor 156.

In order to prevent unnecessary water use, it can be provided that the control device 152 is configured so that it switches the stop valve 126 over after a pre-determined opening time from the release position into the blocking position, even when the control device 152 receives no corresponding signal from the sensor 156.

1. Faucet, comprising
a base,
a hose spray unit and
an arm held on the base, wherein the arm comprises a hose spray unit receptacle on which the hose spray unit is releasably held in a rest position,
wherein the faucet comprises a sensor for the detection of the presence and/or the movement of a hand of an operating person in a detection region of the sensor, wherein the sensor is arranged on the arm.

2. Faucet according to claim 1, wherein the arm has a sensor receptacle in which the sensor is at least partially received.

3. Faucet according to claim 2, wherein the sensor is substantially completely accommodated in the sensor receptacle.

4. Faucet according to claim 2, wherein the sensor receptacle has a sensor aperture through which the sensor is accessible from an exterior of the faucet.

5. Faucet according to claim 4, wherein the detection region of the sensor is arranged laterally beside the arm or beneath the arm.

6. Faucet according to claim 1, wherein in the region in which the sensor is arranged, the arm has a substantially rectangular or oval cross-section.

7. Faucet according to claim 1, wherein the sensor comprises an infrared sensor.

8. Faucet according to claim 1, wherein the faucet comprises a control device which controls a stop valve which permits or blocks the passage of water through the hose spray unit when the sensor detects the presence and/or the movement of a hand of an operating person in the detection region of the sensor.

9. Faucet according to claim 1, wherein the hose spray unit comprises a switch for permitting and/or blocking the passage of water through the hose spray unit and/or for switching over between different jet forms of the water jet emerging from the hose spray unit.

10. Faucet according to claim 9, wherein the switch is arranged on a handle portion of the hose spray unit.

11. Faucet according to claim 9, wherein in the switch is arranged lower than the sensor when the hose spray unit is held in the rest position on the arm.

12. Faucet according to claim 1, wherein the hose spray unit comprises a bendingly flexible hose portion.

13. Faucet according to claim 1, wherein the arm is held pivotable about a pivot axis on the base.

14. Faucet according to claim 13, wherein the arm comprises a base portion and a cantilevered portion extending substantially in the radial direction of the pivot axis away from the base portion, wherein the hose spray unit receptacle is arranged at the end of the cantilevered portion facing away from the base portion and the sensor is arranged on the cantilevered portion of the arm.

15. Faucet according to claim 13, wherein, in the assembled state of the faucet, the horizontal spacing of the sensor from the hose spray unit is smaller than the horizontal spacing of the sensor from the pivot axis.

16. Faucet according to claim 1, wherein the sensor is not visible to an operating person on observing the faucet from a position above the arm.
